(19) United States
(12) Patent Application Publication
(10) Pub. No.: US 2007/0121027 A1
(43) Pub. Date: May 31, 2007

(54) Liquid crystal display

(75) Inventors: Jun-woo Lee, Gyeonggi-do (KR); Hee-seop Kim, Gyeonggi-do (KR); Chang-hun Lee, Gyeonggi-do (KR); Eun-hee Han, Seoul (KR)

Correspondence Address: F. Chau & Associates, LLC, 130 Woodbury Road, Woodbury, NY, 11797, US

(73) Assignee: SAMSUNG ELECTRONICS CO., LTD, Suwon-si (KR)

(21) Appl. No.: 11/503,783

(22) Filed: Aug. 14, 2006

(30) Foreign Application Priority Data
Nov. 30, 2005 (KR) 10-2005-0115851

(51) Int. Cl. G02F 1/1335

(52) U.S. Cl. 349/61

(57) ABSTRACT

A liquid crystal display includes a backlight assembly emitting light, a liquid crystal panel, disposed on the backlight assembly, displaying an image using the light emitted from the backlight assembly and having at least one alignment film, optical sheets, interposed between the backlight assembly and the liquid crystal panel, having a surface which has a prismatic pattern, the prismatic pattern including prisms focusing the light emitted from the backlight assembly, wherein a long edge direction of the prismatic pattern is substantially the same as a rubbing direction of the at least one alignment film, and upper and lower housing units receiving the backlight assembly, the optical sheets, and the liquid crystal panel.

### CROSS-REFERENCE TO RELATED PATENT APPLICATION

This application claims priority from Korean Patent Application No. 10-2005-0115851 filed on Nov. 30, 2005 in the Korean Intellectual Property Office, the contents of which are incorporated herein by reference.

### BACKGROUND OF THE INVENTION

1. Technical Field

The present disclosure relates to a liquid crystal display, and more particularly, to a liquid crystal display capable of improving a viewing angle and brightness and providing a symmetric viewing angle in all directions.

2. Discussion of the Related Art

A liquid crystal display is one of the most widely used flat panel displays. A liquid crystal display includes two glass substrates (plates) provided with electrodes and a liquid crystal layer interposed therebetween. The liquid crystal display displays images by applying voltages to the electrodes to generate an electric field in the liquid crystal layer, which rearranges liquid crystal molecules in the liquid crystal layer to adjust transmittance of incident light.

A liquid crystal display may include thin film transistors (TFT) for switching voltages applied to electrodes on one of the plates. In addition to the TFTs, such a TFT plate further includes gate and data lines, and gate and data pads receiving gate and data signals from an external source and transmitting the received gate and data signals to the gate and data lines. Pixel electrodes are disposed at pixel areas defined by intersections between the gate lines and the data lines and are electrically connected to the TFTs.

Various methods for improving a response speed and a viewing angle of a liquid crystal display have been suggested. One method for improving the response speed and the viewing angle of a liquid crystal display is an optically compensated bend (OCB) mode liquid crystal display.

The OCB mode liquid crystal display includes two opposing panels including various electrodes, a liquid crystal layer inserted between the two panels, alignment films disposed on respective inner surfaces of the two panels, which allow liquid crystal molecules to be aligned horizontally with respect to the two panels, and polarization plates disposed on respective exterior surfaces of the two panels.

In the OCB mode liquid crystal display, a white display is observed by applying a slight voltage to a space between two panels, while a black display is observed by applying a voltage higher than the voltage applied to the space between the two panels. In the OCB mode liquid crystal display, the alignment films of the two panels are rubbed in the same direction, and an initially applied high voltage allows liquid crystal molecules to be perpendicular to the surfaces of the two panels and to have a bend alignment.

The OCB mode liquid crystal display has a wide and symmetrical viewing angle in a direction perpendicular to the rubbing direction, while having a narrow viewing angle in the rubbing direction.

In such a liquid crystal display including two panels, an electric field is generated at a liquid crystal layer by respectively applying a data voltage and a common voltage to a pixel electrode and a common electrode of the two panels. The transmittance of light passing through the liquid crystal layer is controlled by adjusting the intensity of the electric field to create desired images. To prevent image deterioration due to long-time application of a unidirectional electric field to the liquid crystal layer, the polarity of the data voltage with respect to the common voltage is reversed every frame, every row, or every pixel.

However, when the polarity of the data voltage is reversed, the response speed of liquid crystal molecules is decreased. Thus, it takes a long time for a liquid crystal capacitor to reach a target voltage level, thereby causing an image blurring phenomenon. To solve the problem, impulsive driving that inserts a black image between normal images for a short time was developed.

The impulsive driving includes a backlight switching type driving that periodically turns off a backlight lamp to yield black images and a liquid crystal switching type driving that periodically applies a black data voltage, in addition to a normal data voltage substantially participating in image display, to pixels.

According to the backlight switching type driving or the liquid crystal switching type driving, a brightness reduction inevitably occurs due to the “OFF” period of the backlight or a duty ratio.

In order to overcome the above-described viewing angle and brightness problems, a conventional liquid crystal display includes optical sheets. However, there is still a limitation to an improvement in viewing angle although a slight increase in the brightness is achieved. In this regard, when more optical sheets are used to improve the viewing angle, manufacturing costs are increased, making liquid crystal displays ineffective in terms of the manufacturing costs.

### SUMMARY OF THE INVENTION

An exemplary embodiment of the present invention includes a liquid crystal display including a backlight assembly emitting light, a liquid crystal panel, disposed on the backlight assembly, displaying an image using the light emitted from the backlight assembly and having at least one alignment film, optical sheets, interposed between the backlight assembly and the liquid crystal panel, having a surface which has a prismatic pattern of prisms focusing the light emitted from the backlight assembly, wherein a long edge direction of the prismatic pattern is substantially the same as a rubbing direction of the at least one alignment film, and upper and lower housing units receiving the backlight assembly, the optical sheets, and the liquid crystal panel.

An exemplary embodiment of the present invention includes a liquid crystal display including a backlight assembly emitting light, a liquid crystal panel, disposed on the backlight assembly, displaying an image using the light emitted from the backlight assembly, and having a pair of display plates with alignment films, and an optically compensated bend mode liquid crystal layer interposed between the display plates, optical sheets, interposed between the backlight assembly and the liquid crystal panel, having a surface which has a prismatic pattern of prisms focusing the light emitted from the backlight assembly, wherein a long edge direction of the prismatic pattern is substantially the same as the rubbing directions of the alignment films, and upper and lower housing units receiving the backlight assembly, the optical sheets, and the liquid crystal panel.

### BRIEF DESCRIPTION OF THE DRAWINGS

Exemplary embodiments of the present invention can be understood in more detail from the following descriptions taken in conjunction with the attached drawings in which:

FIG. 1 shows an exploded perspective view illustrating a liquid crystal display according to an embodiment of the present invention;

FIG. 2A shows a layout of a liquid crystal panel of FIG. 1;

FIG. 2B shows a sectional view taken along a line IIb-IIb′ of FIG. 2A;

FIG. 3A shows a schematic cross-sectional view of the liquid crystal display of FIG. 1;

FIG. 3B schematically illustrates rubbing directions of alignment films, transmission axes of polarization films, and the long edge direction of a prismatic pattern in a liquid crystal panel of FIG. 3A;

FIG. 4A is a graph illustrating a brightness distribution of light emitted from the liquid crystal display of FIG. 3A;

FIG. 4B is a graph illustrating brightness with respect to viewing angle in the transverse and longitudinal directions of a liquid crystal panel of FIG. 4A; and

FIG. 4C is a graph illustrating brightness with respect to viewing angle in the left and right diagonal directions of the liquid crystal panel of FIG. 4A.

### DETAILED DESCRIPTION OF EXEMPLARY EMBODIMENTS

Exemplary embodiments of the present invention and methods of accomplishing the same may be understood more readily by reference to the following detailed description and the accompanying drawings. The present invention may, however, be embodied in many different forms and should not be construed as being limited to the embodiments set forth herein. Like reference numerals refer to like elements throughout the specification.

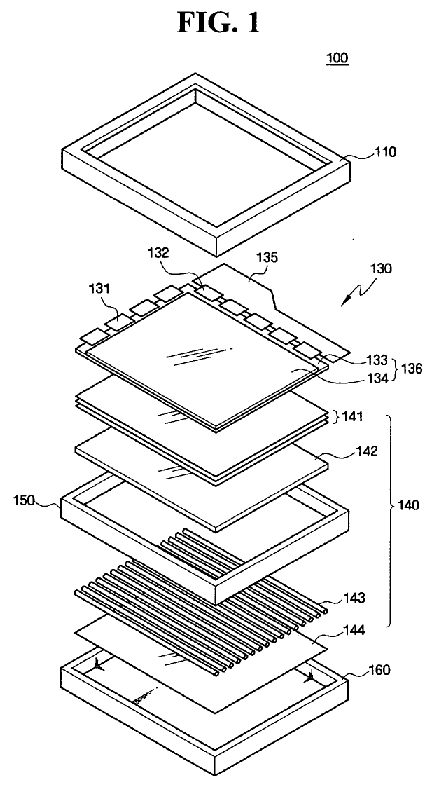

FIG. 1 shows an exploded perspective view illustrating a liquid crystal display according to an embodiment of the present invention. Referring to FIG. 1, the liquid crystal display 100 includes a liquid crystal panel assembly 130, a backlight assembly 140, an upper housing unit 110, and a lower housing unit 160.

The liquid crystal panel assembly 130 includes a liquid crystal panel 136 including a thin film transistor plate 133 and a common electrode plate 134, a liquid crystal layer (not shown), a gate tape carrier package 131, a data tape carrier package 132, and a printed circuit board 135.

The thin film transistor plate 133 includes gate lines (not shown), data lines (not shown), a thin film transistor array (not shown), and pixel electrodes (not shown). The common electrode plate 134 includes a black matrix (not shown), a common electrode (not shown), and faces the thin film transistor plate 133.

The gate tape carrier package 131 is connected to the gate lines formed in the thin film transistor plate 133, and the data tape carrier package 132 is connected to the data lines formed in the thin film transistor plate 133.

Various driving elements for providing a gate driving signal and a data driving signal to the gate tape carrier package 131 and the data tape carrier package 132, respectively, are mounted onto the printed circuit board 135.

The backlight assembly 140 includes optical sheets 141, an optical plate 142, lamps 143, and a reflective plate 144.

The lamps 143 may be light emitted diodes (LEDs), cold cathode fluorescent lamps (CCFLs), or external electrode fluorescent lamps (EEFLs). The lamps 143 receive a lamp driving voltage from an external source and generate light. The lamps 143 may be separated from each other by a predetermined distance and be connected in parallel in the same phase. The lamps 143 may be direct-type lamps. The lamps 143 may be arranged in the transverse direction of the liquid crystal panel 136 to maintain a uniform discharge gas distribution and thus achieve brightness uniformity. Although not shown, lamp holders are positioned at the outermost lamps 143 to support the lamps 143.

The optical plate 142 may be disposed at the upper side of the lamps 143, and enhances the brightness uniformity of light emitted from the lamps 143.

The reflective plate 144 is disposed at the lower side of the lamps 143 to reflect a light beam emitted through the lower side of the lamps 143. The reflective plate 144 may be integrally formed with the bottom of the lower housing unit 160. That is, when the lower housing unit 160 is made of a highly reflective material such as aluminum (Al) or its alloy, it can provide a reflective function. The optical sheets 141 are placed at the upper side of the optical plate 142, and diffuse and focus the light emitted from the lamps 143. The optical sheets 141 include a diffusion sheet, a first prism sheet, and a second prism sheet.

The diffusion sheet is disposed at the upper side of the lamps 143, and enhances the brightness and brightness uniformity of the light emitted from the lamps 143.

The first prism sheet is disposed on the diffusion sheet, and a surface of the first prism sheet has a prismatic pattern composed of a predetermined array of trigonal prisms for focusing the light diffused from the diffusion sheet and outputting the focused light. The first prism sheet may be a brightness enhancement film. The brightness and viewing angle of a liquid crystal display can be enhanced along the long edge direction of the prisms of the prism pattern formed on a surface of the first prism sheet.

The second prism sheet is disposed on the first prism sheet, and is a multi-layered, reflective-type polarization prism sheet for focusing, polarizing, and outputting light. The second prism sheet may be a dual brightness enhancement film. If the brightness and viewing angle of a liquid crystal display can be sufficiently assured by using only the first prism sheet, the second prism sheet may be omitted.

The liquid crystal panel assembly 130 is disposed at the upper side of the optical sheets 141. The liquid crystal panel assembly 130, together with the backlight assembly 140, is received in the lower housing unit 160 while being supported by a receiving frame 150. The receiving frame 150 is a rectangular frame having sidewalls. Inner portions of the sidewalls of the receiving frame 150 have stepped portions or protrusions for supporting the liquid crystal panel assembly 130 and the backlight assembly 140. The lower housing unit 160 is rectangular, and has sidewalls along upper edges and thus receives the backlight assembly 140 and the liquid crystal panel assembly 130 in a receiving space defined by the sidewalls. The lower housing unit 160 also serves to prevent the bending of the backlight assembly 140 including a number of sheets. The printed circuit board 135 of the liquid crystal panel assembly 130 is folded along outer portions of the sidewalls of the lower housing unit 160 to be fitted in the bottom of the lower housing unit 160. The shape of the lower housing unit 160 can be changed according to a method of placing the backlight assembly 140 and the liquid crystal panel assembly 130 in the lower housing unit 160.

The lower housing unit 160 is coupled with the upper housing unit 110 to cover an upper surface of the liquid crystal panel assembly 130 received in the lower housing unit 160. A window (not shown) exposing the liquid crystal panel assembly 130 to the outside is formed at the upper surface of the upper housing unit 110.

The upper housing unit 110 may be hooked and/or screwed to the lower housing unit 160.

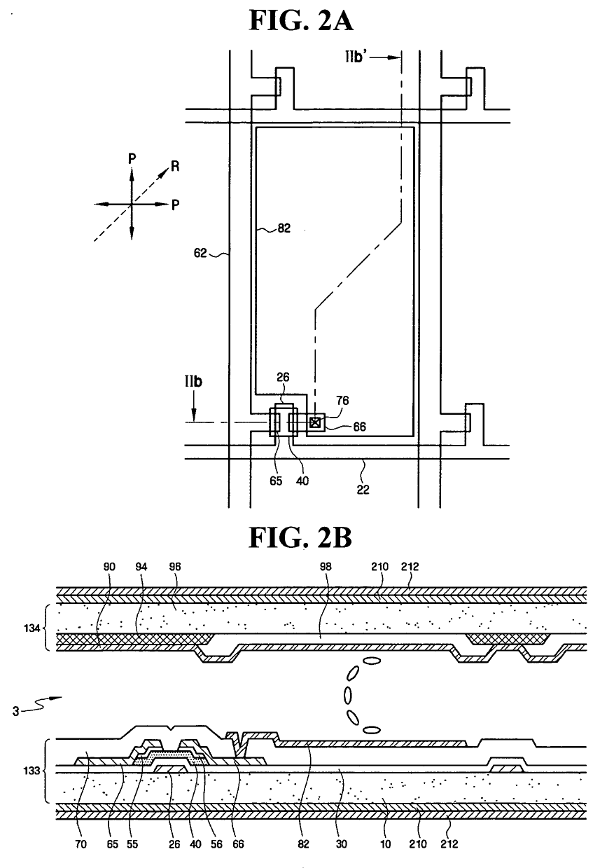

FIG. 2A shows a layout of a liquid crystal panel of FIG. 1, and FIG. 2B shows a sectional view taken along a line IIb-IIb′ of FIG. 2A. Referring to FIGS. 2A and 2B, together with FIG. 1, the liquid crystal panel 136 includes the thin film transistor plate 133, the common electrode plate 134, a liquid crystal layer 3 inserted between the thin film transistor plate 133 and the common electrode plate 134, compensation films 210 attached to respective exterior surfaces of the thin film transistor plate 133 and the common electrode plate 134, and polarization films 212 attached to respective exterior surfaces of the compensation films 210.

In the thin film transistor plate 133, a gate line 22 is formed on an insulating substrate 10 in a transverse direction, and a gate electrode 26 is connected to the gate line 22 in the formed of a protrusion. The gate line 22 and the gate electrode 26 constitute a gate wire.

The gate wire is preferably made of Al containing metal such as Al and Al alloy, Ag containing metal such as Ag and Ag alloy, Cu containing metal such as Cu and Cu alloy, Mo containing metal such as Mo and Mo alloy, Cr, Ti or Ta. In addition, the gate wire may have a multi-layered structure including two conductive films (not shown) having different physical characteristics. One of the two films is preferably made of a low resistivity metal including Al containing metal, Ag containing metal, and Cu containing metal for reducing signal delay or voltage drop in the gate wire. The other film is preferably made of material such as a Mo containing metal, Cr, Ta or Ti, which have good physical, chemical, and electrical contact characteristics with other materials such as indium tin oxide (ITO) or indium zinc oxide (IZO). Examples of combinations of the two films are a lower Cr film and an upper Al containing film and a lower Al containing film and an upper Mo containing film. However, the gate wire may be made of various metals or conductors.

In addition, a storage electrode wire (not shown) extending in a transverse direction in parallel with the gate line 22 may be formed on the insulating substrate 10. A predetermined portion of the storage electrode wire overlaps with the pixel electrode 82, thereby forming a storage capacity. The shape and arrangement of the storage electrode may vary. The pixel electrode 82 may overlap the previous gate line 22 to form a storage capacity, which is called a separate wire type.

A gate insulating layer 30 is formed on the gate wire. The gate insulating layer 30 is made of an insulating material such as silicon nitride (SiNx) or silicon oxide (SiOx).

A semiconductor layer 40 made of hydrogenated amorphous silicon or polycrystalline silicon is formed on the gate insulating layer 30. The semiconductor layer 40 may be formed in various shapes such as an island shape or a stripe shape, and, for example, may be formed in an island shape extending over the gate electrode 26 under the data line 62. When the semiconductor layer 40 is formed in a stripe shape, it may be disposed under the data line 62 and extend up to the gate electrode 26.

Ohmic contact layers 55 and 56, which are made of silicide or n+ amorphous silicon hydride in which an n-type impurity is highly doped, are on the semiconductor layer 40. The ohmic contact layers 55 and 56 may have a variety of shapes such as an island shape or a stripe shape. For example, the ohmic contact layers 55 and 56 may be formed under the drain electrode 66 and the source electrode 65 in an island shape. When the ohmic contact layers 55 and 56 are formed in a stripe shape, they may be disposed and extend under the data line 62.

The data line 62 and the drain electrode 66 are formed on the ohmic contact layer 55 and 56 and the gate insulating layer 30. The data line 62 extends in a longitudinal direction and intersects the gate line 22. The source electrode 65 extending over the semiconductor layer 40 is formed as a branch of the data line 62. The drain electrode 66 is separated from the source electrode 65 and is formed on the semiconductor layer 40 opposite the source electrode 65 in view of the gate electrode 26. The drain electrode 66 includes a bar-type pattern on the semiconductor layer 40 and a drain electrode extension portion having a large area extending from the bar-type pattern and a contact hole 76 therein. The data line 62, the source electrode 65, and the drain electrode 66 constitute a data wire.

The data wire is preferably formed as a single layer or a multiple layer made of at least one material selected from the group consisting of aluminum (Al), chromium (Cr), molybdenum (Mo), tantalum (Ta), and titanium (Ti). For example, the data wire and the storage electrode 67 are preferably made of refractory metal such as Cr, a metal containing Mo, Ta, or Ti. Alternatively, the data wire and the storage electrode 67 may have a multi-layered structure including a lower film (not shown) made of a lower refractory metal film and a low-resistivity upper film (not shown). Examples of the multi-layered structure include a double-layered structure having a lower Cr film and an upper Al containing film, a double-layered structure having a lower Mo containing film and an upper Al containing film, and a triple-layered structure having a lower Mo film, an intermediate Al film, and an upper Mo film.

At least a portion of the source electrode 65 overlaps the semiconductor layer 40, and the drain electrode 66 is opposite to the source electrode 65 in view of the gate electrode 26 and at least a portion of the drain electrode 66 overlaps the semiconductor layer 40. Here, the ohmic contact layers 55 and 56 are interposed between the underlying semiconductor layer 40 and the source electrode 55 and the drain electrode 66 to reduce the contact resistance between them.

A passivation layer 70 is formed of an organic insulating layer on the data wire, the storage electrode 67 and an exposed portion of the semiconductor layer 40. Here, the passivation layer 70 is preferably made of an inorganic insulator such as silicon nitride or silicon oxide, a photosensitive organic material having a good flatness characteristic, or a low dielectric insulating material such as a-Si:C:O and a-Si:O:F formed by plasma enhanced chemical vapor deposition (PECVD).

A contact hole 74 exposing the data line pad 54 and a first contact hole 72 exposing the drain electrode 66 is formed on the passivation layer 70.

A pixel electrode 82 is formed along the shape of a pixel on the passivation layer 70. The pixel electrode 82 is electrically connected to the drain electrode 66 via the contact hole 76. The pixel electrode 82 is made of a transparent conductor such as ITO or IZO or a reflective conductor such as Al.

An alignment layer (not shown) capable of aligning the liquid crystal layer 3 is coated on the pixel electrode 82.

In the common electrode plate 134, a black matrix 94 for preventing light leakage is disposed on an insulating substrate 96 made of a transparent insulating material such as glass. The black matrix 94 partially covers a gate line 22, a data line 62, and a thin film transistor of the thin film transistor plate 133.

A color filter 98 is disposed on portions of the insulating substrate 96 and the black matrix 94 corresponding to each pixel, and is comprised of sequentially arranged red, green, and blue components.

A common electrode 90 made of a transparent conductive material such as indium tin oxide (ITO) or indium zinc oxide (IZO) is disposed on the color filter 98. Here, the common electrode 90 is common to a plurality of pixels.

An alignment film (not shown) allowing liquid crystal molecules of the liquid crystal layer 3 to be aligned in a predetermined direction with respect to the surface of the insulating substrate 96 is disposed on the common electrode 90.

When the common electrode plate 134 and the thin film transistor plate 133 are coupled with a predetermined gap therebetween, the liquid crystal layer 3 inserted between the common electrode plate 134 and the thin film transistor plate 133 has a predetermined cell gap.

Liquid crystal molecules of the liquid crystal layer 3 are aligned so that a liquid crystal display is driven in an optically compensated bend (OCB) mode. That is, in the OCB mode, nematic liquid crystals are set to a splay alignment at an initial state, and when a voltage is applied to a liquid crystal cell, the splay alignment is transferred to a bend alignment, and light transmittance is controlled by adjusting the applied voltage. Alignment films (not shown) are formed on surfaces of a pixel electrode 82 and the common electrode 90 and rubbed so liquid crystal molecules are aligned in a predetermined direction. The alignment films formed on the surfaces of the pixel electrode 82 and the common electrode 90 are rubbed in the same direction so liquid crystal molecules are set to a splay alignment. The alignment films are substantially rubbed in about a 45 degree or about a 135 degree direction with respect to the transverse direction of the liquid crystal panel 136 to reduce the manufacturing costs of the polarization films 212 and to achieve the symmetric viewing angle in all directions.

The compensation films 210 are disposed on respective exterior surfaces of the thin film transistor plate 133 and the common electrode plate 134, and the polarization films 212 are disposed on exterior surfaces of the compensation films 210.

The polarization axes (or transmission axes) of the two polarization films 212 are perpendicular to each other and form an angle of about 45 degrees or about 135 degrees with respect to the rubbing direction of the alignment films.

The compensation characteristics of the compensation films 210 are optimized based on green light. Each of the compensation films 210 is composed of a support and a discotic layer.

The support is a layer that plays a major role in maintaining the shapes of the compensation films 210. Thus, a triacetate cellulose (TAC) film is mainly used as the support. The discotic layer is a compensation layer having a hybrid structure to compensate for the effect of hybrid-aligned liquid crystal molecules.

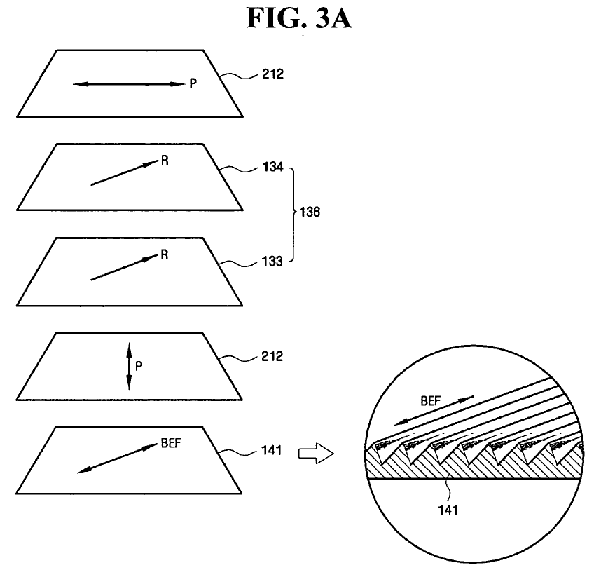

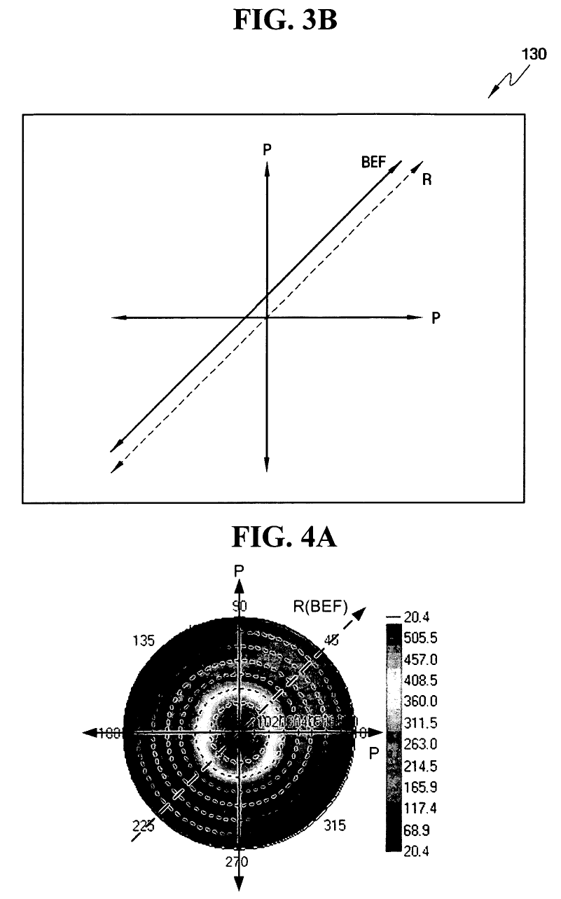

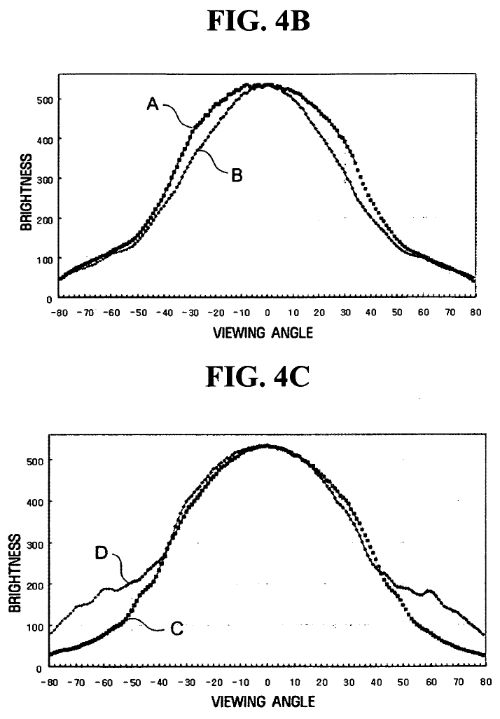

A relation among the rubbing direction of the alignment films, the transmission axes of the polarization films 210, and the long edge direction of the prisms of the prismatic pattern of the first prism sheet will now be described with reference to FIGS. 3A through 4C.

FIG. 3A shows a schematic cross-sectional view of the liquid crystal display of FIG. 1, and FIG. 3B schematically illustrates rubbing directions of alignment films, transmission axes of polarization films, and the long edge direction of a prismatic pattern in a liquid crystal panel of FIG. 3A. FIG. 4A is a graph illustrating a brightness distribution of light emitted from the liquid crystal display of FIG. 3A, FIG. 4B is a graph illustrating brightness with respect to viewing angle in the transverse and longitudinal directions of a liquid crystal panel of FIG. 4A, and FIG. 4C is a graph illustrating brightness with respect to viewing angle in the left and right diagonal directions of the liquid crystal panel of FIG. 4A.

Referring to FIGS. 3A and 3B, a liquid crystal display includes a liquid crystal panel 136 composed of a thin film transistor plate 133 and a common electrode plate 134 that face to each other. As described above, alignment films are respectively disposed on a pixel electrode and a common electrode. The alignment films are rubbed in about a 45 degree direction with respect to the transverse direction of the liquid crystal panel 136, as indicated by a dotted arrow labeled “R”.

A liquid crystal layer (not shown) having positive dielectric anisotropy is interposed between the thin film transistor plate 133 and the common electrode plate 134. At a voltage-OFF state, liquid crystal molecules have a predetermined pretilt angle toward the rubbing direction R and are aligned horizontally with respect to the thin film transistor plate 133 and the common electrode plate 134. On the other hand, at a voltage-ON state, the liquid crystal molecules have a bend alignment. That is, when an electric field is sufficiently applied between the thin film transistor plate 133 and the common electrode plate 134, the long axes of the liquid crystal molecules are aligned substantially parallel to the electric field, i.e., substantially perpendicular to the thin film transistor plate 133 and the common electrode plate 134, due to the positive dielectric anisotropy of the liquid crystal molecules.

Polarization films 212 are attached to exterior surfaces of the thin film transistor plate 133 and the common electrode plate 134. The transmission axes P of the two polarization films 212 are substantially perpendicular to each other, and substantially form an angle of about 45 degrees or about 135 degrees with respect to the rubbing direction R of the alignment films of the thin film transistor plate 133 and the common electrode plate 134. That is, the transmission axes P are substantially parallel to the transverse or longitudinal direction of the liquid crystal panel 136. The polarization films 212 may be formed using an elongation process. A polarization film having a transmission axis parallel to the transverse or longitudinal direction of a rectangular liquid crystal panel can reduce manufacturing costs, compared to a polarization film having a transmission axis parallel to the diagonal direction of a liquid crystal panel.

Optical sheets 141, e.g., first prism sheets, are disposed below the polarization film 212 at the lower side of the thin film transistor plate 133. In a conventional OCB mode liquid crystal display, the viewing angles and the symmetrical property of the viewing angle in a direction perpendicular to the rubbing direction of an alignment film (i.e., in about 135 degree and about 315 degree directions with respect to the transverse direction of a liquid crystal panel) are excellent, whereas the viewing angle in the rubbing direction is reduced. Referring to FIGS. 3A and 3B, a first prism sheet is disposed so the long edge direction, as indicated by an arrow labeled “BEF”, of prisms of a prismatic pattern formed at the first prism sheet is substantially the same as the rubbing direction R. By doing so, light beams diffused from a diffusion sheet are focused on an area of the first prism sheet substantially perpendicular to the rubbing direction R, but are not focused on an area of the first prism sheet parallel to the rubbing direction R. Therefore, a wide viewing angle can be achieved, thereby achieving the symmetric viewing angle. As described above, a liquid crystal display according to the present invention can yield a sufficient viewing angle using only a single first prism sheet, thereby resulting in a reduction in manufacturing costs.

Furthermore, when brightness of a white display does not reach a desired level, a brightness increase can be induced using a second prism sheet. When brightness of a white display reaches a desired level, the second prism sheet is omitted, thereby leading to a further reduction in manufacturing costs.

Referring to FIG. 4A illustrating a brightness distribution of a liquid crystal display according to an embodiment of the present invention, symmetrical viewing angles in all directions can be achieved. A rubbing direction R is the substantially same as a long edge direction of prisms of a prismatic pattern of a first prism sheet, and thus, it is possible to yield a sufficient viewing angle in the rubbing direction R.

Referring to FIG. 4B, a brightness distribution A for the longitudinal direction (e.g., 90 degree direction) of a liquid crystal panel is substantially the same as a brightness distribution B for the transverse direction (e.g., 0 degree direction) of the liquid crystal panel. Both the brightness distributions A and B are symmetrical with respect to a viewing angle of about 0 degrees. Therefore, a liquid crystal display according to the present invention can provide a wide and symmetrical viewing angle in horizontal and vertical directions.

Referring to FIG. 4C, a brightness distribution C for the upper-left diagonal direction (e.g., 135 degree direction) of a liquid crystal panel is substantially the same as a brightness distribution D for the upper-right diagonal direction (e.g., 45 degree direction) within an effective viewing angle range. Both the brightness distributions C and D are symmetrical with respect to a viewing angle of about 0 degrees. Therefore, a liquid crystal display according to the present invention can provide a wide and symmetrical viewing angle in left and right diagonal directions.

The above-described embodiment of the present invention has been illustrated in terms of the viewing angle and the symmetric viewing angle of an OCB mode liquid crystal display. However, the present invention is not limited to the above-illustrated example, and can also be applied to liquid crystal displays having an asymmetrical viewing angle in a particular direction.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A liquid crystal display comprising:
a backlight assembly emitting light;
a liquid crystal panel, disposed on the backlight assembly, displaying an image using the light emitted from the backlight assembly and having at least one alignment film;
optical sheets, interposed between the backlight assembly and the liquid crystal panel, having a surface which has a prismatic pattern, the prismatic pattern including prisms focusing the light emitted from the backlight assembly, wherein a long edge direction of the prismatic pattern is substantially the same as a rubbing direction of the at least one alignment film; and
upper and lower housing units receiving the backlight assembly, the optical sheets, and the liquid crystal panel.

2. The liquid crystal display of claim 1, wherein the liquid crystal display comprises a pair of display plates facing each other and a liquid crystal layer interposed between the pair of display plates, and the at least one alignment film is formed on each of the display plates with substantially the same rubbing direction.

3. The liquid crystal display of claim 1, wherein the rubbing direction of the at least one alignment film forms an angle of about 45 degrees or about 135 degrees with respect to a transverse direction of the liquid crystal panel.

4. The liquid crystal display of claim 1, further comprising a pair of polarization films attached to exterior surfaces of the liquid crystal panel.

5. The liquid crystal display of claim 4, wherein transmission axes of the polarization films are substantially perpendicular to each other, and form an angle of about 45 degrees or about 135 degrees with respect to the rubbing direction of the at least one alignment film.

6. The liquid crystal display of claim 4, wherein transmission axes of the polarization films are substantially parallel to a transverse direction or a longitudinal direction of the liquid crystal panel.

7. The liquid crystal display of claim 1, wherein the prism sheet is a brightness enhancement film.

8. The liquid crystal display of claim 1, wherein the optical sheets further comprise a multi-layered, reflective prism sheet focusing, polarizing, and outputting the light emitted from the backlight assembly.

9. The liquid crystal display of claim 8, wherein the reflective prism sheet is a dual brightness enhancement film.

10. A liquid crystal display comprising:
a backlight assembly emitting light;
a liquid crystal panel, disposed on the backlight assembly, displaying an image using the light emitted from the backlight assembly, and having a pair of display plates with alignment films and an optically compensated bend mode liquid crystal layer interposed between the display plates;
optical sheets, interposed between the backlight assembly and the liquid crystal panel, having a surface which has a prismatic pattern, the prismatic pattern including prisms focusing the light emitted from the backlight assembly, wherein a long edge direction of the prismatic pattern is substantially the same as rubbing directions of the alignment films; and
upper and lower housing units receiving the backlight assembly, the optical sheets, and the liquid crystal panel.

11. The liquid crystal display of claim 10, wherein the rubbing directions of the alignment films are substantially the same.

12. The liquid crystal display of claim 10, wherein the rubbing directions form an angle of about 45 degrees or about 135 degrees with respect to a transverse direction of the liquid crystal panel.

13. The liquid crystal display of claim 10, further comprising a pair of polarization films attached to exterior surfaces of the liquid crystal panel.

14. The liquid crystal display of claim 13, wherein transmission axes of the polarization films are substantially perpendicular to each other and form an angle of about 45 degrees or about 135 degrees with respect to the rubbing directions.

15. The liquid crystal display of claim 13, wherein transmission axes of the polarization films are substantially parallel to the transverse or longitudinal direction of the liquid crystal panel.

16. The liquid crystal display of claim 10, wherein the prism sheet is a brightness enhancement film.

17. The liquid crystal display of claim 10, wherein the optical sheets further comprise a multi-layered, reflective prism sheet focusing, polarizing, and outputting the light emitted from the backlight assembly.

18. The liquid crystal display of claim 17, wherein the reflective prism sheet is a dual brightness enhancement film.
